(19) United States
(12) Patent Application Publication
(10) Pub. No.: US 2026/0356423 A1
(43) Pub. Date: Nov. 12, 2026

(54) Method and Controller for Controlling a Steering System for a Vehicle, and Steering System for a Vehicle

(71) Applicant: KNORR-BREMSE Systeme fuer Nutzfahrzeuge GmbH, Muenchen (DE)

(72) Inventor: Edalat YOUSEFI MAVI, Muenchen (DE)

(21) Appl. No.: 19/140,439

(22) PCT Filed: Dec. 21, 2023
(86) PCT No.: PCT/EP2023/087431

§ 371 Date: Jun. 18, 2025

(30) Foreign Application Priority Data
Jan. 30, 2023 (EP) 23153836.4

(51) Int. Cl. B62D 6/00

(52) U.S. Cl. CPC B62D 6/00

(57) ABSTRACT

A method for controlling a steering system for a vehicle is presented. The method includes a step of determining a uniformity measure of angular position and speed of a shaft of a linkage assembly of the steering system. The shaft is coupled to another shaft of the linkage assembly via a universal joint. The uniformity measure is determined using at least one sensor signal from at least one sensor of the steering system for sensing rotation of the shaft when steering torque is input by a driver of the vehicle. The angular position and speed of the shaft are ascertained from the at least one sensor signal. The method also includes a step of generating a control signal for controlling at least one actuator of a power steering assembly of the steering system. The control signal is generated depending on the uniformity measure to comprise a control parameter defining corrective torque for adjusting torque provided to the linkage assembly by the at least one actuator.

### BACKGROUND AND SUMMARY

The present invention relates to a method for controlling a steering system for a vehicle, to a controller for controlling a steering system for a vehicle and to a steering system for a vehicle.

In vehicle steering systems, universal joints may be used for coupling shafts of a linkage of the steering system to each other. Universal joints, also referred to as U-joints or universal couplings, are not of the constant velocity type, which means that, of the two shafts coupled thereby, only one rotates at constant speed while the other rotates at variable speed. This especially holds for Cardan joints and may cause a non-uniform feeling during steering the vehicle.

Against this background, it is the object of the present invention to provide an improved method for controlling a steering system for a vehicle, an improved controller for controlling a steering system for a vehicle and an improved steering system for a vehicle.

This object is achieved by a method for controlling a steering system for a vehicle, by a controller for controlling a steering system for a vehicle and by a steering system for a vehicle according to the independent claims. The present invention also concerns a computer program and a computer-readable data carrier.

According to embodiments, for example, non-uniformity effects of a universal joint, also referred to as U-joint or universal coupling, in a vehicle steering system may be calculated and then be compensated by correspondingly controlling a power steering unit of the steering system. In other words, for example, there is provided an algorithm for compensating the non-uniformity on an input shaft, introduced by the U-joint of a column shaft of the steering system. In particular, such a function or algorithm may calculate the U-joint non-uniformity effect during steering and compensate it on a power steering assembly in order to advantageously remove the non-uniform steering feeling. Thus, the U-joint non-uniformity effect may be minimized or eliminated, resulting in a uniform feeling during steering of the vehicle. While it may be possible to adjust such a universal joint offset angle during end-of-line tuning in an attempt to minimize this non-uniformity by mechanical adjustment, this would not remove the non-uniformity completely and maybe not even reduce it sufficiently at all, in contrast to the compensation achieved according to embodiments.

A method for controlling a steering system for a vehicle comprises the steps of:
determining a uniformity measure of angular position and speed of a shaft of a linkage assembly of the steering system, wherein the shaft is coupled to at least another shaft of the linkage assembly by means of at least one universal joint, wherein the uniformity measure is determined using at least one sensor signal from at least one sensor of the steering system for sensing rotation of the shaft when steering torque is input by a driver of the vehicle, wherein the angular position and speed of the shaft are ascertained from the at least one sensor signal; and
generating a control signal for controlling at least one actuator of a power steering assembly of the steering system, wherein the control signal is generated depending on the uniformity measure to comprise a control parameter defining corrective torque for adjusting torque provided to the linkage assembly by the at least one actuator.

The vehicle may be a motor vehicle, such as a utility vehicle or commercial vehicle, for example a truck, bus or the like. The method or the steps of the method may be executed using a controller having means therefor. The uniformity measure may represent variations in the angular position and speed of the shaft depending on the rotation angle of the shaft and/or over time. The shaft may be a steering column, steering shaft or coupled to a steering column or steering shaft of the steering system. The at least one universal joint may be a Cardan joint. The at least one sensor signal may directly or indirectly represent the angular position and speed or rotation angle of the shaft. For example, the steering system may comprise two or more sensors to read angular velocity and shaft position or steering shaft position. The control signal with the control parameter may be used to control the at least one actuator to apply corrective torque in addition to the torque provided to the linkage assembly, resulting in adjusted torque. The corrective torque may be calculated so as to even out, counter or compensate the variations in the angular position and speed of the shaft.

According to an embodiment, the step of determining may be executed once to determine a static uniformity measure. Herein, the step of generating may be executed repeatedly using the static uniformity measure. In particular, the step of generating may be executed repeatedly using the static uniformity measure when steering torque is input by a driver of the vehicle. Such an embodiment offers the advantage that U-joint non-uniformity may be compensated by a simple, quick and reliable process at reduced computational overhead.

According to another embodiment, the step of determining may be executed repeatedly to determine a dynamic uniformity measure. Herein, the step of generating may be executed repeatedly using the dynamic uniformity measure. In particular, the step of generating may be executed repeatedly using the dynamic uniformity measure when steering torque is input by a driver of the vehicle. Such an embodiment offers the advantage that U-joint non-uniformity may be compensated in a particularly reliable and exact way, also taking potential changes in U-joint behavior over time into consideration.

According to the previous embodiment, in the step of determining, the dynamic uniformity measure may be stored and updated with each repeated execution of the step of determining. Such an embodiment offers the advantage that it is possible to keep track of potential changes in U-joint behavior over time, resulting in a dynamic uniformity measure that is continuously kept up to date to reflect current behavior of the at least one U-joint.

According to an embodiment, the method may comprise a step of receiving the at least one sensor signal from the at least one sensor via an input interface. Such an embodiment offers the advantage that the at least one sensor signal may be obtained reliably.

According to an embodiment, the method may comprise a step of outputting the control signal to the at least one actuator via an output interface. Such an embodiment offers the advantage that the at least one actuator may be controlled reliably by means of the control signal.

The method or the steps of the method may be executed using a controller. Thus, the method may be executed to control an embodiment of a subsequently mentioned steering system.

The approach presented here also provides a controller configured to execute, control or perform, in corresponding means or units, the steps of a variant of a method presented here. The object underlying the invention may be achieved quickly and efficiently also by this embodiment of the invention in form of a controller.

To this end, the controller may comprise at least one processing unit for processing signals or data, at least one storage unit for storing signals or data, at least one interface to the at least one sensor or an actuator reading sensor signals from the at least one sensor or for outputting control signals to the actuator and/or at least one communication interface for reading or outputting data embedded in a communication protocol. The processing unit may, for example, be a signal processor, a microcontroller or the like, wherein the storage unit may be a flash memory, an EPROM, EEPROM or a magnetic storage unit. The communication interface may be configured to read or output data in a wireless and/or wired manner, wherein a communication interface capable of reading or outputting data via a line may read this data electrically or optically from a corresponding data transmission line or output the same into a corresponding data transmission line, for example.

A controller may be a technical device processing sensor signals and outputting control and/or data signals depending thereon. The controller may comprise an interface, which may be configured as hardware and/or software. If configured as hardware, the interfaces may, for example, be part of a so-called system ASIC including various functions of the controller. However, it is also possible for the interfaces to be discrete integrated circuits or at least partly consist of discrete components. If configured as software, the interfaces may be software modules present on a microcontroller along with other software modules, for example.

A steering system for a vehicle comprises:
a linkage assembly having two or more shafts and one or more universal joints coupling the shafts;
at least one sensor for sensing rotation of one of the shafts;
a power steering assembly having at least one actuator; and
an embodiment of the controller mentioned herein, wherein the controller is communicatively connected to the at least one sensor and to the at least one actuator.

The steering system or, more specifically, operation of the steering system may be controlled by means of the controller, wherein the controller comprises means for carrying out the steps of an embodiment of the method mentioned herein.

What is also advantageous is a computer program product or to program with program code which may be stored on a machine-readable carrier or storage medium, such as a semiconductor memory, a hard-drive memory or an optical memory, and is used for executing, performing/controlling the steps of the method according to one of the embodiments previously described, in particular when the program product or program is executed on a computer or a device, such as a controller.

Embodiments of the approach presented here shall be explained in greater detail in the subsequent description with reference to the figures.

### BRIEF DESCRIPTION OF THE DRAWINGS

FIG. 1 is a schematic illustration of a vehicle comprising a steering system according to an embodiment of the present invention; and

FIG. 2 is a flowchart of a method for controlling a steering system for a vehicle according to an embodiment of the present invention.

In the following description of advantageous embodiments of the present invention, the same or similar reference numerals shall be used for the elements depicted in the various figures and acting in a similar way, wherein repeated description of these elements shall be omitted.

### DETAILED DESCRIPTION OF THE DRAWINGS

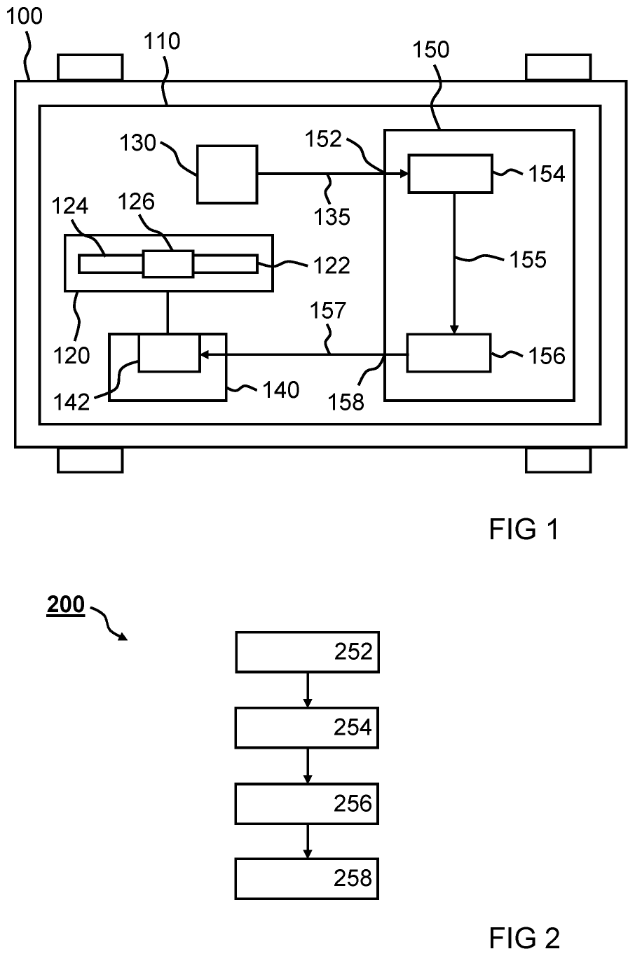

FIG. 1 shows a schematic illustration of a vehicle 100 comprising a steering system 110 according to an embodiment of the present invention. The vehicle 100 is a utility vehicle or commercial vehicle, such as a truck, for example. The steering system 110 comprises a linkage assembly 120, at least one sensor 130, a power steering assembly 140 and a controller 150.

The linkage assembly 120 comprises a rotatably arranged shaft 122, at least another rotatably arranged shaft 124 and at least one universal joint 126, in particular a Cardan joint or the like, for coupling the shaft 122 to the at least one other shaft 124. The at least one universal joint 126 is also referred to as a U-joint or universal coupling. The shaft 122 and the at least one other shaft 124 of the linkage assembly 120 are mechanically coupled to each other by the at least one universal joint 126. In particular, the shaft 122 is a steering column or is coupled to a steering column of the steering system 110.

The at least one sensor 130 of the steering system 110 is configured and arranged to sense rotation of the shaft 122. The at least one sensor 130 is also configured to provide at least one sensor signal 135, which represents angular position and speed of the shaft 122 or from which angular position and speed of the shaft 122 can be ascertained. According to an embodiment, the steering system 110 may comprise two or more sensors 130 to read angular velocity and position of the shaft 122 or steering shaft.

The power steering assembly 140 comprises at least one actuator 142. The power steering assembly 140 is coupled to the linkage assembly 120. The actuator 142 is configured to provide torque to the linkage assembly 120.

The controller 150 is communicatively connected to the at least one sensor 130 and to the actuator 142 of the power steering assembly 140 .The controller 150 is configured to control the steering system 110. To this end, the controller 150 comprises a device 154 for determining and a device 156 for generating. According to the embodiment illustrated here, the controller 150 also comprises an input interface 152 and an output interface 158.

The controller 150 is configured to receive the at least one sensor signal 135 from the at least one sensor 130 via the input interface 152. The device 154 for determining is configured to determine a uniformity measure 155 of angular position and speed of the shaft 122 of the linkage assembly 120 using the at least one sensor signal 135 from the at least one sensor 130 when steering torque is input by a driver of the vehicle 100. Optionally, the device 154 for determining is configured to ascertain the angular position and speed of the shaft 122 from the at least one sensor signal 135. The device 154 for determining is configured to pass the uniformity measure 155 on to the device 156 for generating.

The device 156 for generating is configured to generate a control signal 157 for controlling the at least one actuator 142 of the power steering assembly 140 depending on the uniformity measure 155. The device 156 for generating is configured to generate the control signal 157 depending on the uniformity measure 155 to comprise a control parameter defining corrective torque for adjusting the torque provided to the linkage assembly 120 by the actuator 142. The controller 150 is configured to output the control signal 157 to the actuator 142 via the output interface 158. Thus, U-joint non-uniformity effects may be compensated, minimized and/or eliminated.

FIG. 2 shows a flowchart of a method 200 for controlling a steering system for a vehicle according to an embodiment of the present invention. The steps of the method 200 for controlling are executable by the controller of FIG. 1 or a similar controller. The method 200 is executable to control the steering system of FIG. 1 or a similar steering system. The method 200 for controlling comprises a step 254 of determining and a step 256 of generating.

In the step 254 of determining, a uniformity measure of angular position and speed of a shaft of a linkage assembly of the steering system is determined. The shaft is coupled to at least another shaft of the linkage assembly by way of at least one universal joint. In the step 254 of determining, the uniformity measure is determined using at least one sensor signal from at least one sensor of the steering system for sensing rotation of the shaft when steering torque is input by a driver of the vehicle. The angular position and speed of the shaft are ascertained from the at least one sensor signal.

In the step 256 of generating, a control signal for controlling at least one actuator of a power steering assembly of the steering system is generated depending on the uniformity measure. In the step 256 of generating, the control signal is generated depending on the uniformity measure to comprise a control parameter defining corrective torque for adjusting torque provided to the linkage assembly by the at least one actuator.

According to an embodiment, the step 254 of determining is executed once to determine a static uniformity measure, and the step 256 of generating is executed repeatedly using the static uniformity measure. As an alternative, the step 254 of determining is executed repeatedly to determine a dynamic uniformity measure, and the step 256 of generating is executed repeatedly using the dynamic uniformity measure. Optionally, in the step 254 of determining, the dynamic uniformity measure is also stored and updated with each repeated execution of the step 254 of determining.

According to an embodiment, the method 200 for controlling further comprises a step 252 of receiving the at least one sensor signal from the at least one sensor via an input interface. According to an embodiment, the method 200 for controlling also comprises a step 258 of outputting the control signal generated in the step 256 of generating to the at least one actuator via an output interface.

### REFERENCE NUMERAL LIST

100 vehicle
110 steering system
120 linkage assembly
122 shaft
124 other shaft
126 universal joint
130 sensor
135 sensor signal
140 power steering assembly
142 actuator
150 controller
152 input interface
154 device for determining
155 uniformity measure
156 device for generating
157 control signal
158 output interface
200 method for controlling
252 step of receiving
254 step of determining
256 step of generating
258 step of outputting

1.-10. (canceled)

11. A method for controlling a steering system of a vehicle, the method comprising the steps of:
determining a uniformity measure of angular position and speed of a shaft of a linkage assembly of the steering system, wherein the shaft is coupled to at least another shaft of the linkage assembly via at least one universal joint, wherein the uniformity measure is determined using at least one sensor signal from at least one sensor of the steering system for sensing rotation of the shaft when steering torque is input by a driver of the vehicle, wherein the angular position and speed of the shaft are ascertained from the at least one sensor signal; and
generating a control signal for controlling at least one actuator of a power steering assembly of the steering system, wherein the control signal is generated depending on the uniformity measure to comprise a control parameter defining corrective torque for adjusting torque provided to the linkage assembly by the at least one actuator

12. The method according to claim 11, wherein
the step of determining is executed once to determine a static uniformity measure, and
the step of generating is executed repeatedly using the static uniformity measure.

13. The method according to claim 11, wherein
the step of determining is executed repeatedly to determine a dynamic uniformity measure, and
the step of generating is executed repeatedly using the dynamic uniformity measure.

14. The method according to claim 13, wherein, in the step of determining, the dynamic uniformity measure is stored and updated with each repeated execution of the step of determining.

15. The method according to claim 11, further comprising the step of:
receiving the at least one sensor signal from the at least one sensor via an input interface.

16. The method according to claim 15, further comprising the step of:
outputting the control signal to the at least one actuator via an output interface.

17. A controller, comprising:
a computer implemented controller operatively configured to:
determine a uniformity measure of angular position and speed of a shaft of a linkage assembly of the steering system, wherein the shaft is coupled to at least another shaft of the linkage assembly via at least one universal joint, wherein the uniformity measure is determined using at least one sensor signal from at least one sensor of the steering system for sensing rotation of the shaft when steering torque is input by a driver of the vehicle, wherein the angular position and speed of the shaft are ascertained from the at least one sensor signal; and
generate a control signal for controlling at least one actuator of a power steering assembly of the steering system, wherein the control signal is generated depending on the uniformity measure to comprise a control parameter defining corrective torque for adjusting torque provided to the linkage assembly by the at least one actuator.

18. A steering system for a vehicle, comprising:
a linkage assembly having a first shaft, at least one second shaft and at least one universal joint coupling the first and second shafts;
at least one sensor for sensing rotation of the first shaft;
a power steering assembly having at least one actuator; and
a controller communicatively connected to the at least one sensor and to the at least one actuator,
wherein the controller is operatively configured to:
determine a uniformity measure of angular position and speed of the first shaft of the linkage assembly of the steering system, wherein the uniformity measure is determined using at least one sensor signal from the at least one sensor of the steering system for sensing the rotation of the first shaft when steering torque is input by a driver of the vehicle, wherein the angular position and speed of the shaft are ascertained from the at least one sensor signal; and
generate a control signal for controlling the at least one actuator of a power steering assembly of the steering system, wherein the control signal is generated depending on the uniformity measure to comprise a control parameter defining corrective torque for adjusting torque provided to the linkage assembly by the at least one actuator.

19. A computer product comprising a non-transitory computer readable medium having program code stored thereon which, when the program code is executed by a computer, causes the computer to carry out the acts of:
determining a uniformity measure of angular position and speed of a shaft of a linkage assembly of the steering system, wherein the shaft is coupled to at least another shaft of the linkage assembly via at least one universal joint, wherein the uniformity measure is determined using at least one sensor signal from at least one sensor of the steering system for sensing rotation of the shaft when steering torque is input by a driver of the vehicle, wherein the angular position and speed of the shaft are ascertained from the at least one sensor signal; and
generating a control signal for controlling at least one actuator of a power steering assembly of the steering system, wherein the control signal is generated depending on the uniformity measure to comprise a control parameter defining corrective torque for adjusting torque provided to the linkage assembly by the at least one actuator.
